(19) United States
(12) Patent Application Publication
(10) Pub. No.: US 2011/0137707 A1
(43) Pub. Date: Jun. 9, 2011

(54) Customer experience improvement system and method

(75) Inventors: William Winfield, Upper Marlboro, MD (US); David Richey, Washington, DC (US)

(73) Assignee: Richey International, Ltd., Chevy Chase, MD (US)

(21) Appl. No.: 12/653,153

(22) Filed: Dec. 8, 2009

(51) Int. Cl. G06Q 10/00; G06Q 50/00; G06F 15/16; G06F 17/30

(52) U.S. Cl. 705/7.29; 709/203; 709/206; 707/802; 707/E17.044; 705/7.38

(57) ABSTRACT

A customer experience improvement system and method for the hospitality industry is disclosed. Embodiments of the present invention provide a system and method for entering customer experience issues into a computer system that maintains records in a database. The user is guided to enter information that allows for collaboration, and identification of a root cause. Solutions for the customer experience issues can then be developed. Report tools provide an overview of various types of issues.

### FIELD OF THE INVENTION

The present invention relates to a system and method for tracking and resolving customer experience issues. More particularly, the present invention relates to a system and method for tracking and resolving customer experience issues in the hospitality industry.

### BACKGROUND OF THE INVENTION

The hospitality industry is very competitive. Discriminating travelers on both business and leisure travel are demanding superb service. Therefore, hotels and resorts are very focused on offering an excellent customer experience in order to improve the REVPAR (Revenue per Available Room), generate additional repeat business, and spread a quality reputation for their organization. While top hotels and resorts put significant effort towards customer satisfaction, often times, with large resorts handling thousands of guests per month, issues can “slip through the cracks” and not get handled in a proper or timely way. With the advent of travel blogs, online travel sites such as Tripadvisor®.com, social networks, and online video sharing networks such as “YouTube®,” a single bad customer experience can disseminate to the world faster than ever before. Therefore, what is needed is a customer experience improvement system to minimize the occurrences of poor customer experiences.

### SUMMARY OF THE INVENTION

In one embodiment of the present invention, a method is provided for improving customer experience at a hotel in which various information is input into a computerized customer experience improvement system. The information that is input into the system includes a description of a customer experience issue, an issue type for the customer experience issue, an experience type for the customer experience issue, a target implementation date for the customer experience issue, and a root cause for the customer experience issue. A solution for the customer experience issue is then identified and the solution is implemented.

The step of inputting a root cause can comprise, for example, selecting a choice from the group consisting of employee knowledge, employee effort, preparation, policy, and anomaly.

The step of inputting an experience type can comprise, for example, selecting a choice from the group consisting of reservations, transportation, arrival, departure, guest services, telephone, business, and room.

The step of inputting an issue type can comprise, for example, selecting an option from the group consisting of Meeting Expectations and Above and Beyond Expectations.

The method can further comprise inputting an easy fix indication for the customer experience issue into the customer experience improvement system. The name of a responsible manager for the customer experience issue can also be input into the customer experience improvement system. Still further, names of solutions team members for the customer experience issue can be input into the customer experience improvement system.

In a further embodiment of the present invention, a system is provided for improving customer experience at a hotel. A user interface is provided for inputting a description of a customer experience issue, an issue type for the customer experience issue, an experience type for the customer experience issue, a target implementation date for the customer experience issue, and a root cause for the customer experience issue into the system. Means are provided for recording a solution for the issue.

The input of a root cause can comprise selecting a choice from the group consisting of employee knowledge, employee effort, preparation, policy, and anomaly. The input of an experience type can comprise selecting a choice from the group consisting of reservations, transportation, arrival, departure, guest services, telephone, business, and room. The input of an issue type can comprise selecting a choice from the group consisting of Meeting Expectations and Above and Beyond Expectations. The system can further provide for the input of an easy fix indication for the customer experience issue, a name of a responsible manager for the customer experience issue, and/or names of solutions team members for the customer experience issue.

A system is also disclosed for improving customer experience at a hotel, in which a plurality of client computers is provided. Each client computer comprises a computer-readable medium comprising machine instructions enabling the computer to communicate via a data communications network. An application server is configured to provide a user interface to the plurality of clients over the data communications network. A data server is configured to receive data storage and retrieval requests from the plurality of client computers via the data communications network. A database is configured to communicate with the data server. The database is adapted to store and retrieve data indicative of one or more issues and information about each user of the system.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

In the drawings accompanying the description that follows, often both reference numerals and legends (labels, text descriptions) may be used to identify elements. If legends are provided, they are intended merely as an aid to the reader, and should not in any way be interpreted as limiting.

FIG. 1 shows an embodiment of a status dashboard, in accordance with the present invention.

FIG. 2 shows an embodiment of a home screen, in accordance with the present invention.

FIG. 3 shows an embodiment of an issue entry screen, in accordance with the present invention.

FIG. 4 shows an embodiment of an additional issue information screen, in accordance with the present invention.

FIGS. 5A and 5B show report generation screens, in accordance with the present invention.

FIG. 6A shows a system block diagram of an embodiment of the present invention.

FIG. 6B shows a system block diagram of an alternative embodiment of the present invention.

FIG. 7 is a flowchart showing process steps for carrying out a method in accordance with an embodiment of the present invention.

FIG. 8 is a flowchart showing process steps for performing entry of new issues in accordance with an embodiment of the present invention.

### DETAILED DESCRIPTION OF THE INVENTION

Embodiments of the present invention provide a customer experience improvement system and method for the hospitality industry. Hotels and resorts strive to deliver an excellent customer experience for each of their guests. For the purposes of this disclosure, the term “hotel” is used to conveniently refer to a hotel, motel, resort, or any other lodging establishment. Even in the best run hotels and resorts, issues arise from time to time that warrant investigation by management, staff, and other stakeholders. Embodiments of the present invention provide a collaborative tool that allows the team of stakeholders to focus on an appropriate solution for such issues, as well as provide a way to measure and record the effectiveness of that solution once implemented.

Embodiments of the system are implemented via one or more computers executing machine instructions from software that allows users to enter, update, and delete customer experience issues. The user interface screens are designed to prompt the users for the appropriate data, and guide the user's thought process to collaborate and devise the most feasible solution for the situation.

Example user interface screens are referenced in the following description. Those skilled in the art will recognize that details such as button and field placement, and the use of specific controls, such as list-boxes, are shown for example purposes, and other user interface layouts are possible within the scope of the present invention.

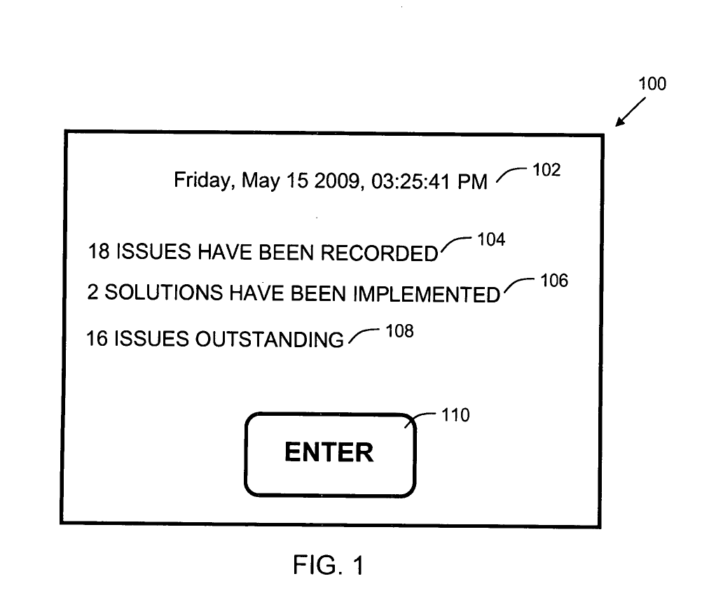

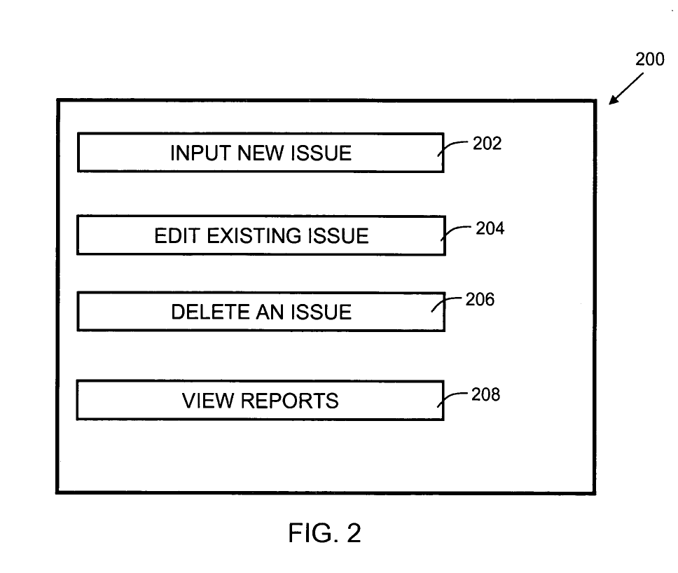

FIG. 1 shows an embodiment of a status dashboard 100 as displayed on the computer screen of a computer system (not shown). Status dashboard 100 is displayed upon system startup, and provides a quick overview of progress to date. The current date and time is displayed in data field 102. The total number of recorded issues is displayed in data field 104. The number of implemented solutions is displayed in data field 106. The number of outstanding issues, for which no solution has been implemented, is displayed in data field 108. Actuation of enter button 110 via a computer mouse, touch screen input, or the like displays a home screen 200 as illustrated in FIG. 2, which serves as the main menu of the program.

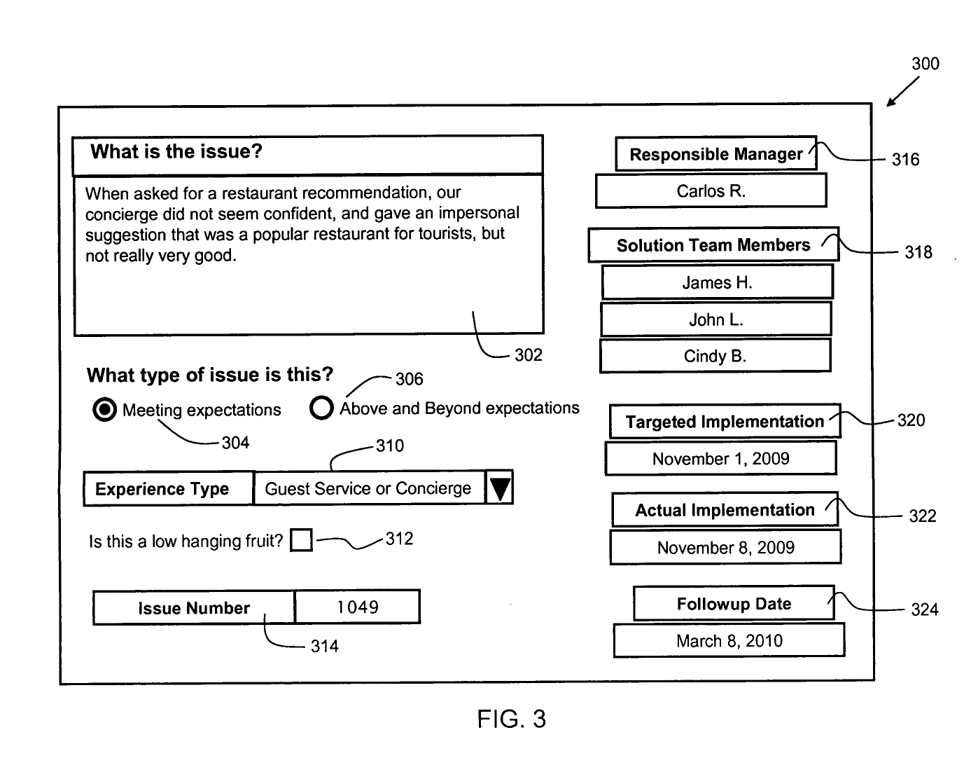

In the embodiment of the home screen 200 shown in FIG. 2, the user is presented with four options, preferably implemented via a selectable button or link. Button 202 invokes a user interface for entering a new issue by causing the computer system to display an issue entry screen (shown in FIG. 3). Button 204 invokes a user interface for editing an existing issue. Button 206 invokes a user interface for deleting an issue. Button 208 invokes a user interface for generating reports.

FIG. 3 illustrates an embodiment of an issue entry screen 300 as displayed on a computer screen. Data field 302 provides space for allowing the user to enter a description of an issue. The user then sets the issue type, by classifying the issue into one of two categories: Meeting Expectations 304, or Above and Beyond Expectations 306. For issues involving a problem of achieving a basic and expected service, the “Meeting Expectations” 304 is the appropriate choice. For issues that, if resolved, would reach above the obvious, and exceed the guest's expectation, then the “Above and Beyond Expectations” 306 is the appropriate choice.

Experience Type 310 is preferably implemented as a “list box” (also known as a “drop down box”) type control, wherein the user is presented with a finite number of choices to categorize the issue. In one embodiment, the following choices are offered:

Experience Type Choices

Reservations and Pre-Arrival (reservations)
Transportation (transportation)
Hotel Arrival (arrival)
Hotel Departure (departure)
Guest Service or Concierge (guest services)
Telephone Services (telephone)
Business Services (business)
Guest Room Presentation upon Arrival (room)

The basic categories for experience types (shown in parenthesis in the table) are reservations, transportation, arrival, departure, guest services, telephone, business, and room. The actual text presented in the user interface may vary, so long as the notion of each basic category is conveyed. Other choices may be offered without departing from the scope of the present invention. However, the number of choices should not be so high as to require undue time for a user to complete the issue entry.

Checkbox 312 is an easy fix indication that provides a way for the user to denote this issue as a “low hanging fruit,” meaning that it is relatively easy to solve quickly, and hence should be considered for prompt action. By selecting checkbox 312, the user is denoting this issue as an “easy fix” issue. When left unchecked, it denotes that this issue is not an easy fix issue, and hence, is not a “low hanging fruit.” An example of such a low hanging fruit issue may be to ensure that there is always a supply of clean towels in the pool area.

Data field 314 shows an automatically assigned issue number which is generated when a new issue is entered. The issue number provides a convenient way to track and retrieve issues. Data field 316 provides space for entering a responsible party for the issue, typically a manager. Data field 318 provides space for entering a plurality of solution team members. Data field 320 provides space for entering a targeted implementation date. This is the planned execution date. Data field 322 provides space for entering the actual date the solution was implemented. Data field 324 provides space for entering a followup date. In one embodiment, the followup date is automatically entered based on the actual implementation date 322. For example, the system can be configured to enter a followup date at set time interval (e.g. 90 days) from the actual implementation date.

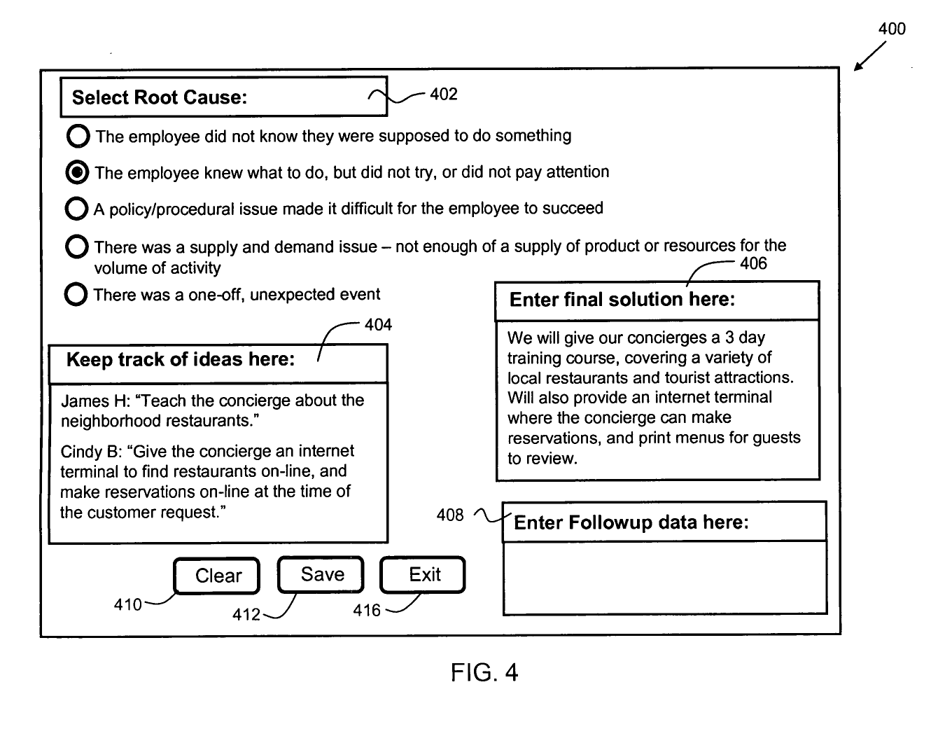

FIG. 4 shows an embodiment of an additional issue information screen 400 as displayed on a computer screen. Root cause section 402 provides a way for the user to select a root cause from one of a plurality of possible root causes. The user chooses the root cause that best fits the issue. In one embodiment, the following possible root causes are presented to the user:

Possible Root Causes

The employee did not know they were supposed to
do something (employee knowledge)
The employee knew what to do, but did not try, or
did not pay attention (employee effort)
A policy/procedural issue made it difficult for the
employee to succeed. (policy)
There was a supply and demand issue-not enough
of a supply of product or resources for the volume
of activity (preparation)
There was a one-off, unexpected event (anomaly)

The basic categories for root causes (shown in parenthesis in the table) are employee knowledge, employee effort, policy, preparation, and anomaly. The actual text presented in the user interface may vary, so long as the notion of each basic category is conveyed.

Data field 404 provides space for each solution team member to post thoughts and ideas about the solution. These posts are available for all the solution team members and the responsible manager to view. Once the ideas are posted, and the team has an opportunity to discuss the possible solutions, a final solution is chosen, and entered in data field 406. This is the solution that will get implemented. Followup data is entered in data field 408 once the solution has been in place for a predetermined amount of time (e.g. 90 days). The followup data is used to evaluate the effectiveness of the solution.

Button 410 is used to clear the form if the user desires to clear previously entered data and start over. Button 412 is used to save the data to a storage device, such as a hard disk, flash, or non-volatile memory, thereby recording the issue data in the computer system. In one embodiment, a database is used to manage the storage and retrieval of the issue data. Button 416 is used to exit the data entry screen.

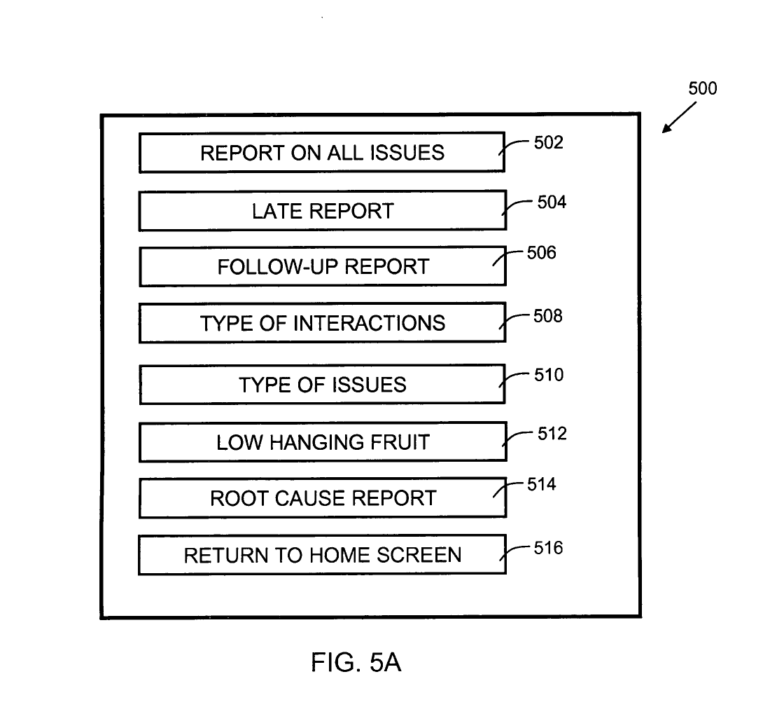

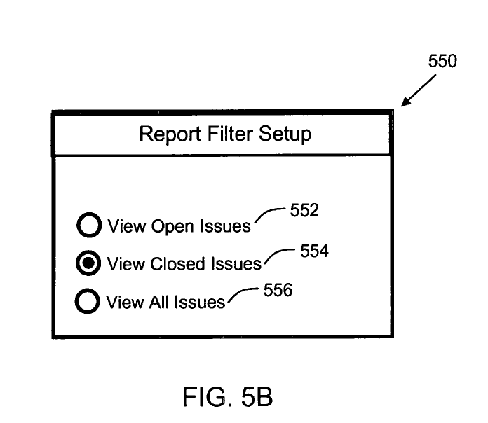

FIGS. 5A and 5B show report generation screens as displayed on a computer screen. In FIG. 5A, report selection screen 500 displays a plurality of buttons for the various reports that are available. For example, invoking button 502 causes the system to generate a report of all issues.

Invoking button 504 causes the system to generate a late report, showing all issues that were not implemented as of the targeted implementation date (from data field 320 FIG. 3).

Invoking button 506 causes the system to generate a follow-up report. This report contains issues that will require followup in the near future. Each issue in the followup report has been solved, but has not yet reached its followup date.

Invoking button 508 causes the system to generate a “type of interactions” report. This report sorts issues as they relate to each department or interaction, thereby allowing each department to have its issues listed succinctly on a single page.

Invoking button 510 causes the system to generate “type of issues” report. This report sorts issues based on the type, as either “meeting a basic expectation” or “above and beyond” as per the selection made on screen 300, using Meeting Expectations 304, or Above and Beyond Expectations 306. With this report, the user can observe the number of each type of issue, and ensure that there is an appropriate balance amongst the two types of issues. It is important to meet basic expectations, but in the competitive arena of hotels and resorts, it is good to devote at least some effort to going “above and beyond.” Similarly, it is not preferable to focus only on the “above and beyond” issues at the expense of neglecting issues pertaining to meeting basic expectations. This report helps assess the balance between the two types of issues.

Invoking button 512 causes the system to generate a report of the easy fix (“low hanging fruit”) issues. Each low hanging fruit issue is quick and easy to solve. By identifying the low hanging fruit issues, it is possible to resolve numerous issues quickly, so the team can then focus on the more challenging issues.

Invoking button 514 causes the system to generate a root cause report. The root cause report is a snapshot of the sources of the issues, as categorized by the root cause. The issues are shown as percentages of each of the root causes that are available (see 402 of FIG. 4). In one embodiment, the root cause report may also include a graphical representation of the root causes, such as a pie chart or bar chart.

Invoking button 516 allows the user to return to the home screen (see 200 of FIG. 2).

FIG. 5B shows an embodiment of a report filter setup screen. This allows the user to filter the report based on the open or closed status of an issue, or include both open and closed issues in a report. When the user generates a report with the “View Open Issues” 552 radio button selected, any reports generated will contain only open issues (issues that do not have a solution yet). When the user generates a report with the “View Closed Issues” 554 radio button selected, any reports generated will contain only closed issues (issues that have been resolved). When the user generates a report with the “View All Issues” 556 radio button selected, any reports generated will contain both open and closed issues.

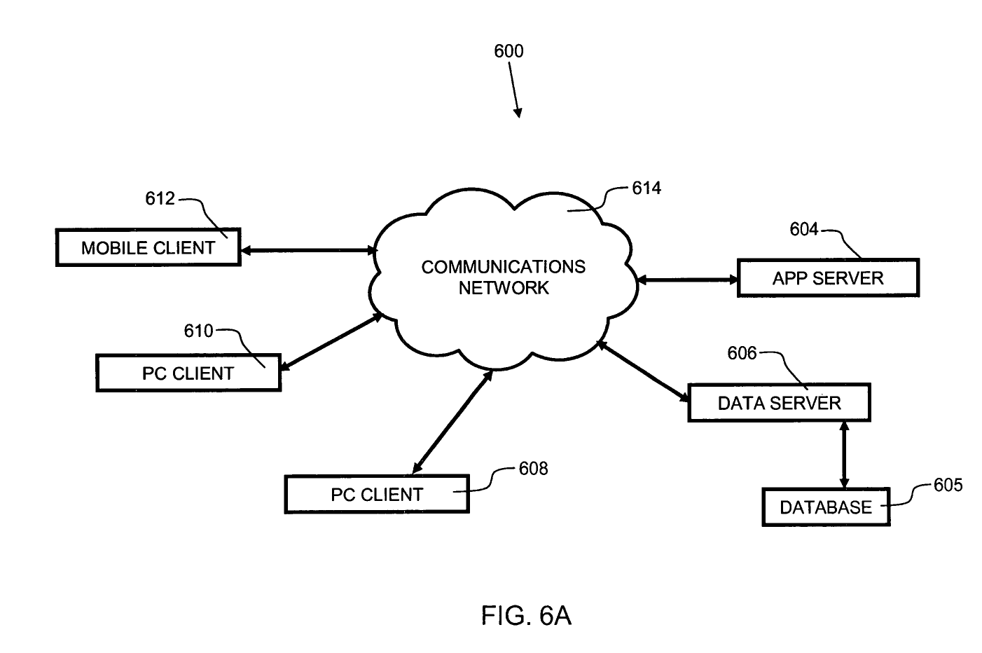

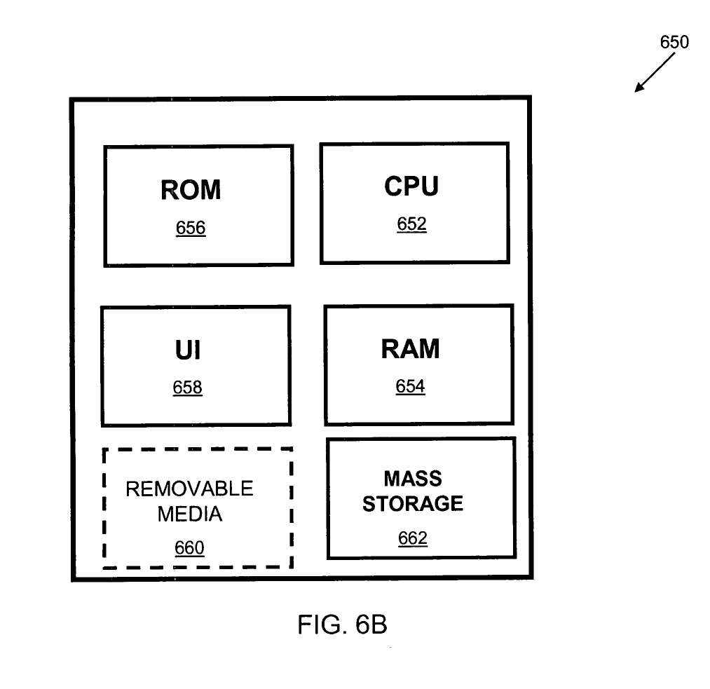

FIG. 6A shows a block diagram of system 600 which is an embodiment of the present invention. System 600 comprises a plurality of PC (personal computer) client devices 608 and 610. System 600 optionally may comprise one or more mobile clients 612. Mobile client 612 may comprise a PDA or mobile telephone, such as a “smart phone,” or other networked communication device that is capable of communicating via a wireless data network, such as a cellular telephone system. System 600 also comprises data server 606, which serves and stores data in database 605. Database 605 contains information about users of the system (solution team members and managers) such as names, departments, as well as credentials (login information).

App server 604 provides a “front end” for a user interface. In one embodiment, the user interface is a web-based user interface utilizing HTML pages. Additional web technologies such as Java, Javascript, and XML may be utilized to implement data entry, data validation, and other data processing functionality. To access the system, each user logs into the system, and selects the desired issues to update, or enters new issues.

In one embodiment, all stakeholders (solution team members, responsible manager, and other interested parties) can receive a notification anytime an issue is updated, or when a new issue meeting certain criteria is entered. The criteria are used to select a predetermined subset of issues for which to receive notifications on. For example, a manager responsible for hotel arrival can get notifications of any new issues in the category of hotel arrival. In one embodiment, the notifications are in the form of an e-mail sent to a user e-mail account. In another embodiment, a text message is sent to the user's mobile phone, indicating that new issues have been entered, and/or existing issues have been updated. A communications network 614 provides a means for the client devices (608, 610, and 612) to communicate with app server 604 and data server 606. The communications network 614 can comprise, for example, the Internet or a private network.

FIG. 6B shows a system block diagram of a system 650 in accordance with an alternative embodiment of the present invention. This embodiment is self-contained to operate on a standalone personal computer (PC), such as a desktop, laptop, or netbook, for example. System 650 comprises random access memory (RAM) 654, read-only memory (ROM) 656, and a user interface (UI) 658. System 650 also comprises a Central Processing Unit (CPU) 652 that executes machine instructions from a computer-readable medium (such as RAM 654 or ROM 656) to implement the user interface screens discussed previously. The user interface 658 typically comprises a display screen, a data entry device, such as a keyboard or touch screen, and a cursor manipulation device, such as a mouse or trackball (not shown). System 650 may optionally comprise mass storage device 662, which is typically a hard disk. System 650 may also optionally comprise removable media 660. In one embodiment, removable media 660 comprises a USB memory stick that contains the machine-readable instructions that execute on CPU 652. Program data, such as user information and data records for each issue may be stored in mass storage device 662. Alternatively, all program data may be stored on removable media device 660. By keeping the software program and the program data on removable media, a stakeholder (such as a manager or solutions team member) can easily bring the entire system and program data to a variety of locations. This is useful in a situation where a user may travel to various geographic locations to visit multiple hotels of a chain, and can then invoke the program on any suitable PC at that location.

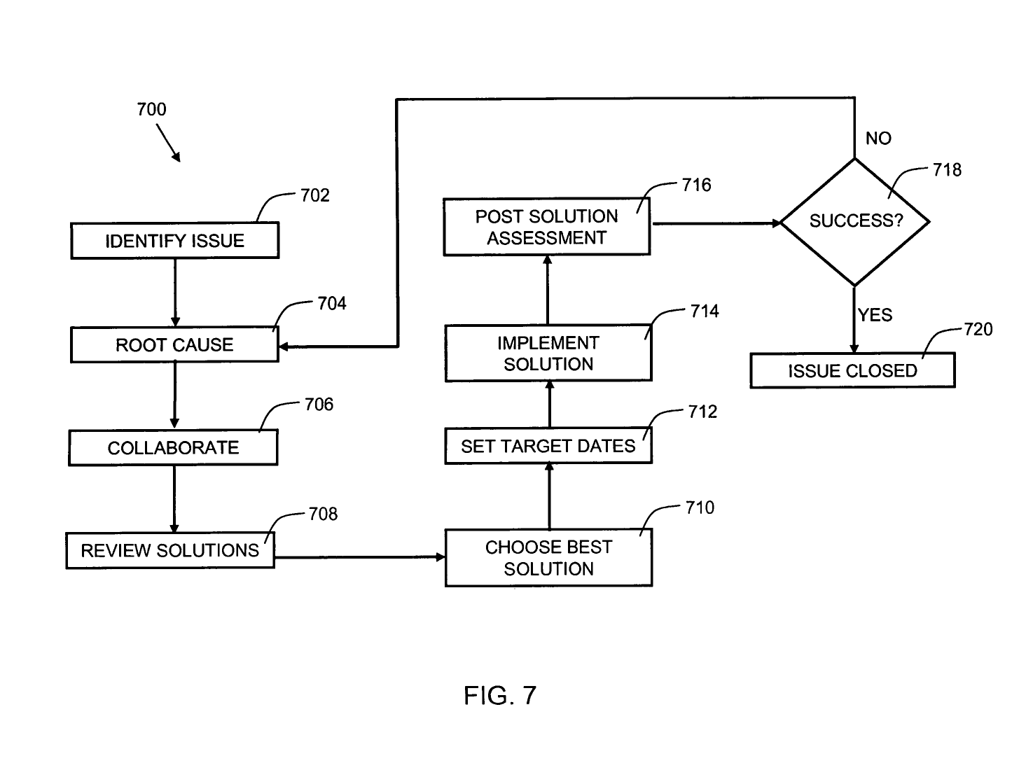

FIG. 7 is a flowchart 700 showing process steps for carrying out a method in accordance with an embodiment of the present invention. In process step 702, candidate issues are identified for entry into the system. While hotels and resorts often have a variety of issues, using selection criteria for selecting the issues increases the effectiveness of the system. In one embodiment, the selection criteria comprises selecting issues that are important to creating positive guest experiences, and that can be succinctly stated, with a clear cause identified. Furthermore, selecting issues that involve a single predominant root cause and a single department increases the effectiveness of the system. In one embodiment, prior to the initial use of the system by a hotel, each department within a hotel selects two issues that are a “Meeting Expectations” (see 304 of FIG. 3) type of issue, and one issue that is a “Above and Beyond Expectations” (see 306 of FIG. 3) type of issue. Once all issues are resolved, and solutions are implemented, each department continues to select two additional issues, and the process repeats, as customer experience improvement is an ongoing process.

An example of a “Meeting Expectations” type of issue is:
Often, there were no clean towels in the basket at the pool.

An example of an “Above and Beyond Expectations” issue is:
When guests receive small parcels or faxes at the hotel prior to their arrival, make it extra-convenient for the guests to receive them.

In step 704, a root cause is chosen (compare 402 of FIG. 4). In process step 706, solutions team members collaborate by entering suggestions, questions, and comments regarding the issue, into the system (compare 404 of FIG. 4). In process step 708, each proposed solution is reviewed to determine if it is feasible. In some cases, solutions may be combined in whole or in part, to produce the solution that is ultimately chosen in process step 710.

In process step 712, target dates are set for implementing the solution. In process step 714, the solution is implemented and the date of implementation is entered into the system (compare 332 of FIG. 3). In process step 716, a post-solution assessment is conducted. In one embodiment, this is performed about 90 days after the solution is implemented. This provides an opportunity to gauge the effectiveness of the solution. For example, guest surveys can be collected to see if the rate of complaints on a particular issue has reduced significantly after the deployment of the solution. The success of the solution is then evaluated in process step 718. If the solution is deemed to be successful, the issue is closed in process step 720. If the solution is deemed to be unsuccessful, then the process reverts to step 704, where the process repeats, until the issue is ultimately closed once a successful solution has been achieved.

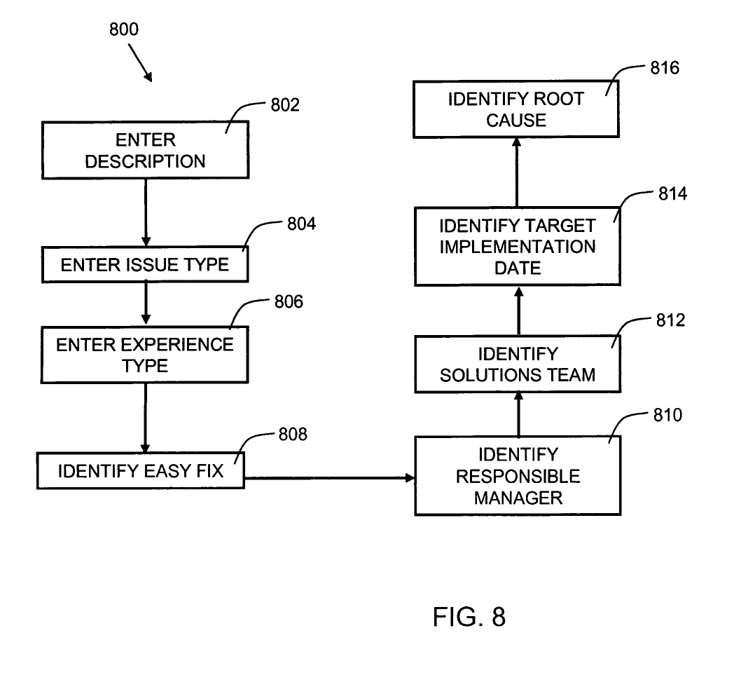

FIG. 8 is a flowchart 800 showing process steps for performing entry of new issues in accordance with an embodiment of the present invention. In process step 802, a description of the issue is entered (compare 302 of FIG. 3). In process step 804, the type of the issue is selected (compare 304 and 306 of FIG. 3). In process step 806, the experience type is selected (compare 310 of FIG. 3). In process step 808, the “easy fix” status of the issue is indicated (compare 312 of FIG. 3). In process step 810, the name of the responsible manager is entered (compare 316 of FIG. 3). In process step 812, the names of the solution team members are entered (compare 318 of FIG. 3). In process step 814, the target implementation date is entered (compare 320 of FIG. 3). In process step 816, a root cause is selected (compare 402 of FIG. 4).

It should now be appreciated that the present invention provides a customer experience improvement system and method for the hospitality industry. Customer experience issues are entered into a computer system that maintains records in a database. The user is guided to enter information that enables problems to be identified and allows for collaboration in providing successful solutions. Issues identified and solved can relate to meeting the expectations of customers and, on a higher level, to going above and beyond the expectations of customers to provide a superior quality of service. Report tools provide an overview of various types of issues.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for improving customer experience within the hospitality industry, comprising the steps of:
inputting a description of a customer experience issue into a customer experience improvement system;
inputting an issue type for the customer experience issue into the customer experience improvement system;
inputting an experience type for the customer experience issue into the customer experience improvement system;
inputting a target implementation date for the customer experience issue into the customer experience improvement system;
inputting a root cause for the customer experience issue into the customer experience improvement system;
identifying a solution for the customer experience issue; and
implementing the solution.

2. The method of claim 1, wherein the step of inputting a root cause comprises selecting a choice from the group consisting of employee knowledge, employee effort, preparation, policy, and anomaly.

3. The method of claim 1, wherein the step of inputting an experience type comprises selecting a choice from the group consisting of reservations, transportation, arrival, departure, guest services, telephone, business, and room.

4. The method of claim 1, wherein the step of inputting an issue type comprises selecting an option from the group consisting of Meeting Expectations and Above and Beyond Expectations.

5. The method of claim 1, further comprising the steps of:
inputting an easy fix indication for the customer experience issue into the customer experience improvement system;
inputting a name of a responsible manager for the customer experience issue into the customer experience improvement system; and
inputting names of solutions team members for the customer experience issue into the customer experience improvement system.

6. A system for improving customer experience at a hotel or the like, comprising:
a computer system for processing information entered as input thereto;
a user interface operatively associated with said computer system for enabling a user to input and view said information;
said user interface allowing said user to:
enter a description of a customer experience issue into the system;
enter an issue type for the customer experience issue into the system;
enter an experience type for the customer experience issue into the system;
enter a target implementation date for the customer experience issue into the system; and
enter a root cause for the customer experience issue into the system;
wherein said computer system is adapted to assist the user in developing a solution for the customer experience issue and to record said solution.

7. The system of claim 6, wherein the entry of a root cause is facilitated by said user interface by providing for selection of a choice from the group consisting of employee knowledge, employee effort, preparation, policy, and anomaly.

8. The system of claim 6, wherein the entry of an experience type is facilitated by said user interface by providing for selection of a choice from the group consisting of reservations, transportation, arrival, departure, guest services, telephone, business, and room.

9. The system of claim 6, wherein the entry of an issue type is facilitated by said user interface by providing for selection of a choice from the group consisting of Meeting Expectations and Above and Beyond Expectations.

10. The system of claim 6, wherein said user interface further allows said user to:
enter an easy fix indication for the customer experience issue;
enter a name of a responsible manager for the customer experience issue into the system; and
enter names of solutions team members for the customer experience issue into the system.

11. A system for improving customer experience at a hospitality facility, comprising:
a plurality of client computers, each client computer comprising a computer-readable medium comprising machine instructions for communicating via a data communications network;
an application server, said application server configured to provide a user interface to the plurality of client computers over the data communications network;
a data server, said data server configured to receive data storage and retrieval requests from the plurality of client computers via the data communications network; and
a database configured to communicate with the data server, said database comprising means for storing and retrieving data, wherein the data comprises one or more issues and information about each user of the system.

12. The system of claim 11, wherein the application server is configured to provide said user interface over the data communications network via HTML pages.

13. The system of claim 12, further comprising a mobile client, wherein the mobile client is configured to communicate with the application server via a wireless data network.

14. The system of claim 13, further comprising means for notifying users of updates to any issue within a predetermined subset.

15. The system of claim 14, wherein the means for notifying users of updates comprises sending an e-mail to a user e-mail account.

16. The system of claim 14, wherein the means for notifying users of updates comprises sending a text message to a user mobile device.

17. The system of claim 11, further comprising means for generating a plurality of reports summarizing issues that have been previously entered into the system.

18. The system of claim 17, wherein the plurality of reports comprises:
a report on all issues;
a report on late issues;
a report on issues requiring followup;
a report sorted by type of interactions;
a report sorted by type of issue;
a report on easy fix issues; and
a report indicating number of issues categorized by each root cause.

19. The system of claim 18, further comprising means for filtering issues based on the criterion of the issue being open or closed.
